(19) United States
(12) Patent Application Publication
(10) Pub. No.: US 2003/0233364 A1
(43) Pub. Date: Dec. 18, 2003

(54) Group management program and group management method

(75) Inventors: Hisayasu Nakao, Kawasaki (JP); Toshiro Shibanuma, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/340,753

(22) Filed: Jan. 13, 2003

(30) Foreign Application Priority Data
Jun. 4, 2002 (JP) 2002-163377

(51) Int. Cl. G06F 7/00

(52) U.S. Cl. 707/100

(57) ABSTRACT

A group management program for performing modifications (for example additions and deletions) to members of a group which is constituted by a plurality of members, comprising a member database which holds information concerning the plurality of members. This group management program performs verification as to whether a member who accesses the group management functions is a member of the group, receives a member modification request (or proposal) from the verified member, receives approvals of the request made by the verified member, and reflects the requested and approved member modification in the member database when preset conditions on the request and/or approval are satisfied. All of the members of the group are provided with equal authority to perform the aforementioned requests and approvals. Thus, all members may perform member modifications and as a result member modifications may be performed autonomously and in a timely fashion.

### BACKGROUND OF THE INVENTION

1. Field of the Invention

The present invention relates to a group management program and a group management method, and more particularly to a group management program and group management method in which group members have equal managerial authority and there is no need for a specified group manager.

2. Description of the Related Art

Client/server systems constituted via the Internet or Intranet are being utilized to form groups comprising members who have work, hobbies, and so on in common. Various information and functions are provided only to the members of the group, thereby boosting exchanges among the members and enhancing the convenience of the members. In order to form such groups and support the activities thereof, it is necessary to perform group management tasks such as adding and deleting group members.

A group management program (typically referred to as “groupware”) which is installed in a server system is used in such group management to appropriately support a group member database. A group management program also performs verification of members who have requested access to various information and functions, permitting such access to valid members.

In a typical group management program, one or a plurality of managers is specified for all of the groups or for each group, and this specified manager alone has the authority to add or delete members. The group management program accesses the member database to verify a manager who is requesting the addition or deletion of a member. Only a valid manager who has been verified may make modifications to the member list such as member additions and deletions.

A method is proposed in Japanese Patent Application Number 2000-227879 for preventing someone who is not a group manager, such as a server manager or an invalid, unauthorized party, from adding or deleting members by limiting managers who possess the authority to add or delete members to specified members from among the group members, and by performing verification using a public key or secret key of the manager. A specific member from within the group is designated as the manager in this example also, and only this manager has the authority to add or delete members. The manager also has the authority to add or delete other managers.

In conventional group management, only a specified manager has the authority to add or delete members, and therefore when the manager is absent due to a business trip, holiday or the like, members cannot be added or deleted. Furthermore, if a manager has the authority to modify other managers, other managers cannot be added or deleted when the manager is absent. Thus, member and manager modification tasks are focused solely on a specific manager, and as a result, in groups where member and manager changes occur frequently, these modification tasks cannot be performed in a timely fashion.

Further, in groups with the objective of promoting exchange among members having shared hobbies or the like, and in which there is accordingly no need for strict member management, relying upon a specific manager for member addition and deletion is troublesome, and there are cases in which it would be better to rely on the autonomy of the members. Moreover, in groups which are characterized in that all members have equal authority, determining a specific manager who has the authority to add and delete members does not conform to the policy of the group.

### SUMMARY OF THE INVENTION

It is therefore an object of the present invention to provide a group management program and a group management method in which member modification tasks can be performed in a timely fashion without granting a specific manager the authority to add and delete members.

In order to achieve the aforementioned object, one aspect of the present invention is a group management program for performing modifications (for example additions and deletions) to members of a group which is constituted by a plurality of members, comprising a member database which holds information concerning the plurality of members. This group management program performs verification as to whether a member who accesses the group management functions is a member of the group, receives a member modification request (or proposal) from the verified member, receives approvals of the request made by the verified member, and reflects the requested and approved member modification in the member database when preset conditions on the request and/or approval are satisfied. All of the members of the group are provided with equal authority to perform the aforementioned requests and approvals.

When group management is performed using this group management program, the authority to perform group management, for example modifications such as member additions and deletions, is not limited to a specific manager but provided equally to all members. Thus, all members may perform member modifications and as a result member modifications may be performed autonomously and in a timely fashion. Note that in order to limit group management authority to the members of a group, at least the measure of permitting only members who have been verified as a member of the group to make requests and grant approvals is taken.

In a preferred embodiment of the invention described above, the right to make a member modification request (or proposal) and the right to grant approval is limited to members who have satisfied equal conditions such as the elapse of a fixed period of time following member registration. In so doing, mistaken member management by a newly-registered member who is not yet accustomed to the group can be prevented.

In a further preferred embodiment of the invention described above, the aforementioned set conditions may be set appropriately in accordance with the character of the group such that (1) a request (or proposal) is made by one member (the request itself signifying the approval of the originator of the request), (2) a predetermined number of members approve the request (or proposal), (3) a predetermined number of member approve the request (or proposal) within a predetermined period of time, (4) a predetermined of time pass since the request, and so on. By appropriately setting the set conditions in this manner, the level of management may be tightened or relaxed despite the fact that member management is performed autonomously by the members.

### BRIEF DESCRIPTION OF THE DRAWINGS

FIG. 1 is a block diagram of a group management system according to this embodiment;

FIG. 2 is a view showing the relationship between an umbrella group and individual groups;

FIG. 3 is a flowchart showing an outline of the functions of a group management program;

FIG. 4 is a view showing a login screen and a menu screen in the group management program;

FIG. 5 is a flowchart of group creation processing;

FIG. 6 is a view showing a group creation screen and an initial condition setting screen thereof;

FIG. 7 is a flowchart of member addition processing in the group management program;

FIG. 8 is a view showing a member addition screen;

FIG. 9 is a flowchart of member deletion processing in the group management program;

FIG. 10 is a view showing a member deletion screen;

FIG. 11 is a flowchart of member approval processing in the group management program, and is also a view showing a member approval screen;

FIG. 12 is a view showing a member approval screen;

FIG. 13 is a view showing a member approval screen;

FIG. 14 is a view showing a member approval screen;

FIG. 15 is a view showing a member database; and

FIG. 16 is a view showing a member database.

### DESCRIPTION OF THE PREFERRED EMBODIMENTS

An embodiment of the present invention will be explained below with reference to the drawings. The scope of protection of the present invention, however, is not limited to or by the following embodiment, but covers the inventions appearing in the claims for the patent and equivalent items thereof.

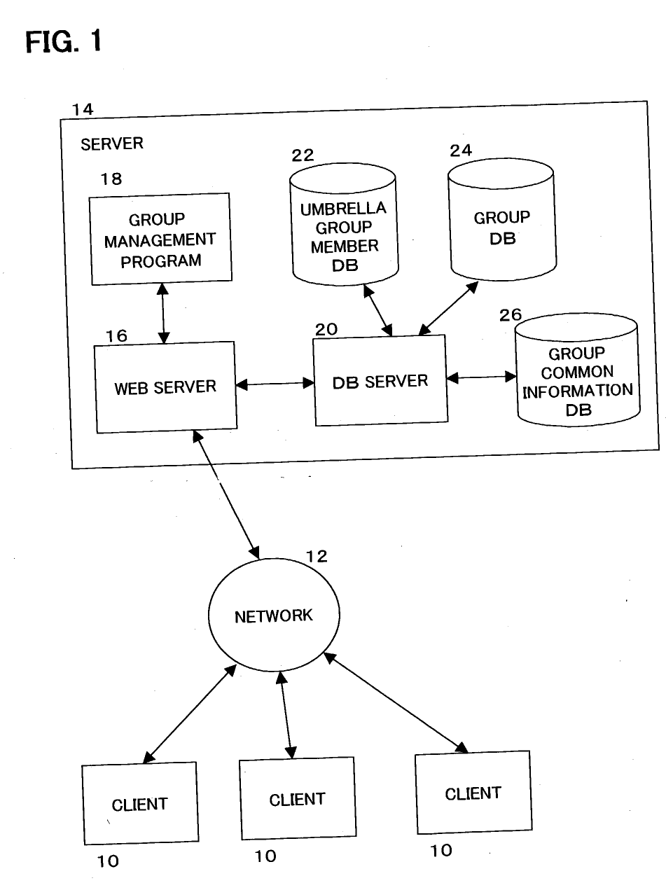

FIG. 1 is a block diagram of the group management system according to this embodiment. In the group management system of FIG. 1, a plurality of clients 10 which are terminal devices used by members, and a server 14 having a group management function may be connected via a network 12 such as the Internet or Intranet.

The server 14 comprises a web server 16 which provides websites to a client 10 which makes access via a network, and a database server 20 which controls access to a database in response to a request from a client transmitted to the web server 16 or in response to the execution of a group management program 18. Included in the database, for example, are an umbrella group member database 22 holding information on the umbrella group which is constituted by members who have agreed to prescribed membership terms, a group database 24 holding information on the members of each group and member addition and deletion conditions, and a group common information database 26 holding information which is shared among the members in each group.

In this embodiment, various groups are constituted by the members of the umbrella group. Accordingly, these various groups will be referred to hereafter as individual groups in order to differentiate them from the umbrella group.

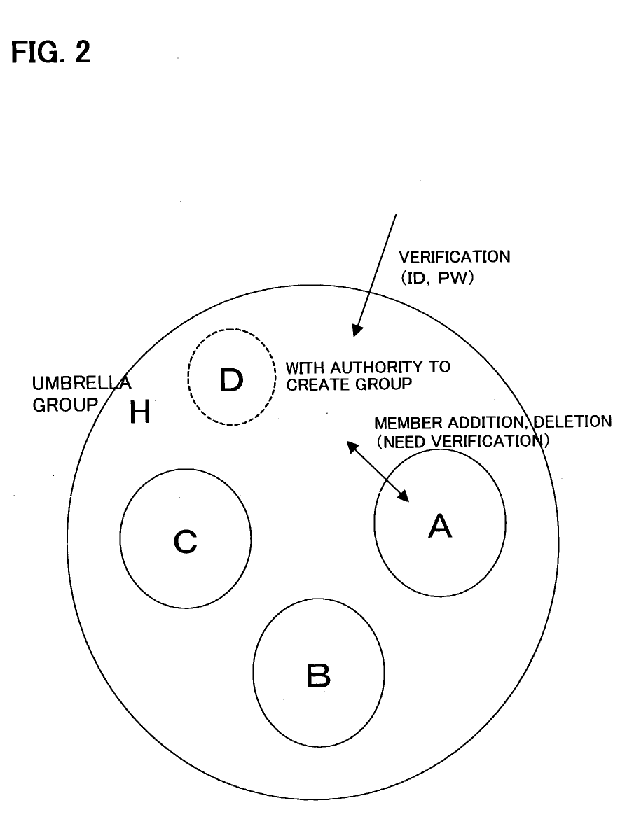

FIG. 2 is a view showing the relationship between the umbrella group and the individual groups. FIG. 2 illustrates an assembly of members H which constitute the umbrella group, and the assemblies of individual groups A to D constituted by the members of the umbrella group. In order to enter the group management site of the umbrella group, the person requesting access must be verified, and in this embodiment, verification is performed using a member ID and a password PW. Of course, stricter verification may also be performed using such means as a public key and secret key. Members who are successfully verified are granted the authority to create a new group comprising members of the umbrella group.

One condition for proposing and approving the addition and deletion of members to and from the individual groups is that the member who makes such a proposal or approval be a member of the individual group. A member is identified by the verification process performed during entry into the group management site of the umbrella group, and hence the group management program is able to verify whether or not the member is a member of the individual group as a background process without requesting input or the like in order to perform verification anew.

When a member of the umbrella group is to be registered to an individual group, the member is added to the individual group following a proposal and approval by members of the individual group. The member is also removed from the individual group following a proposal and approval by members of the individual group. As noted previously, the members of the umbrella group are also permitted to create a new individual group. Those who accept these conditions in advance are registered as members of the umbrella group.

When a member of the umbrella group creates an individual group, the created individual group is added to the group database 24, and when addition or deletion of a member of the added individual group is proposed and approved, this is reflected in the group database 24. The authority (authority of proposal and approval) to add and delete members of the individual group is provided equally to all of the members of the individual group as a general principle.

When a member of an individual group wishes to access information which is shared among the members of the group, this access is permitted on the condition that the accessing party be a member of that individual group. When predetermined functions provided to the individual group are to be accessed, access to these functions is also permitted on the condition that the accessing party be a member of that individual group.

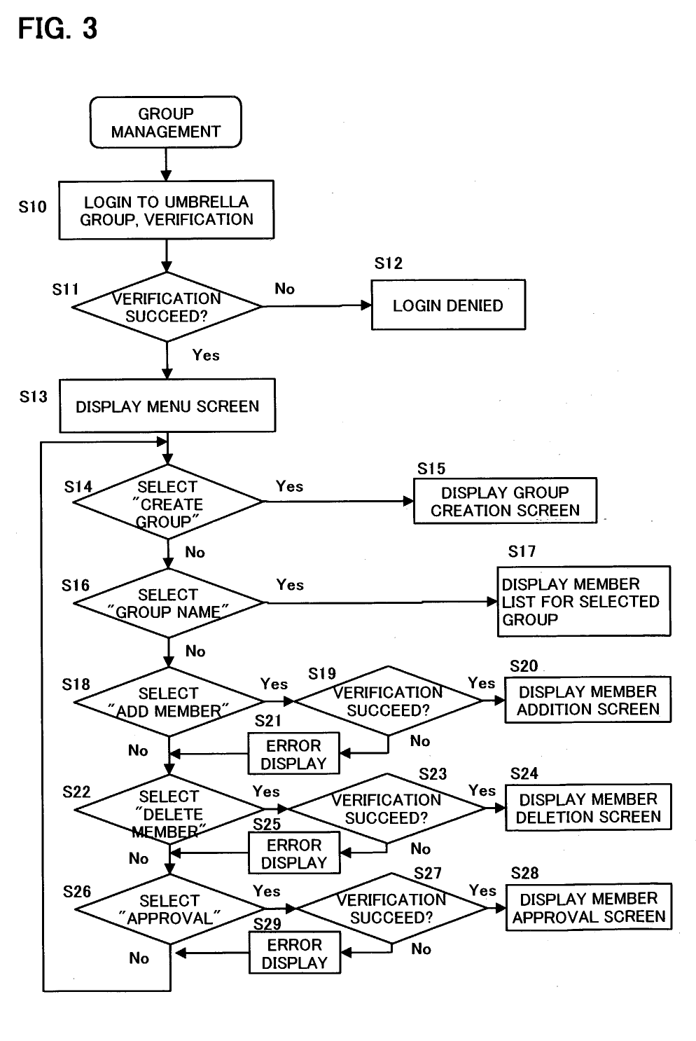

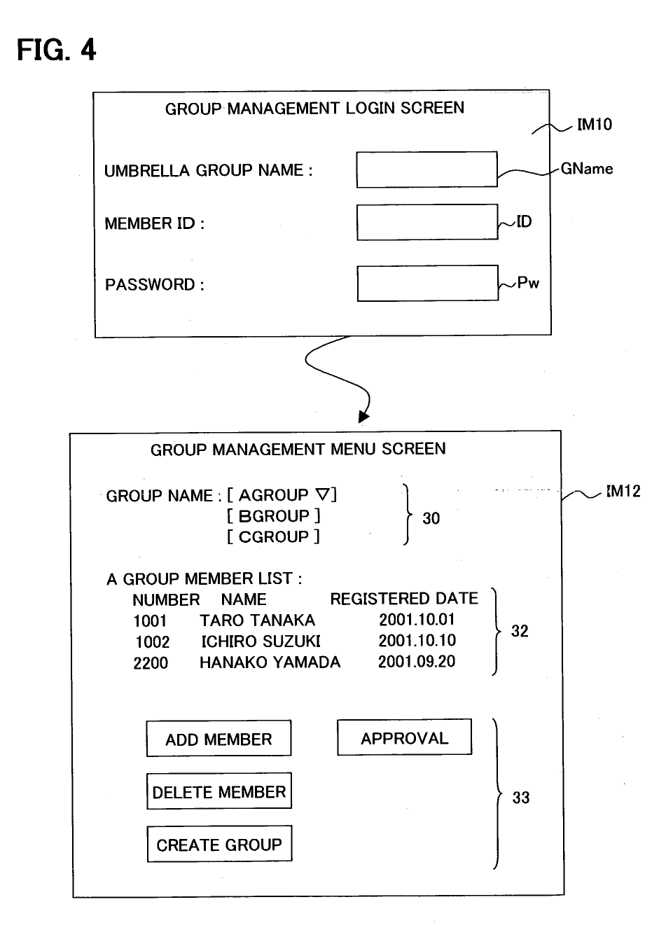

The functions of the group management program 18 will be described in detail herein below. FIG. 3 is a flowchart showing an outline of the functions of a group management program. FIG. 4 is a view showing a login screen and a menu screen in the group management program. In order to access the group management site from a client 10, the umbrella group, which is the object of group management, must be logged into. As is illustrated on the login screen IM10 in FIG. 4, the client side is prompted to input the umbrella group name Gname, a member ID and a password PW. When this information has been inputted, it is transmitted to the web server 16. The group management program 18 in the web server 16 verifies whether or not the accessing party is a valid member on the basis of data which is stored in the umbrella group member DB through the database server 20 (S1). If the accessing party is verified as being valid (S11), the data of a group management menu screen are transmitted to the client 10 from the web server 16 and displayed on the display of the client (S13). This group management menu screen IM12 is as shown in FIG. 4. When verification is not successful, login is denied (S12).

The group management menu screen IM12 comprises an individual group selection region 30, a selected individual group member list region 32, and a group management menu button region 33. In FIG. 4, “Group A” has been selected as the individual group, and accordingly the member list of “Group A” is displayed in the member list region 32. The member list region 32 displays the number, name and registration date of each member. When it is impossible to display all of the members, the display becomes a scroll screen display, and a search function may be added according to necessity.

In the menu button region 33, four menu buttons—add member, delete member, create group, approval—are displayed, and when these buttons are clicked on the client side, the respective processing screens are displayed on the condition that the accessing member is a member of the selected individual group.

Thus, if an accessing party does not successfully complete verification processing as a member of the umbrella group, s/he is unable to gain entry into the group management site of the umbrella group. Further, when the addition or deletion of a member of an individual group is proposed and approved following entry into the group management site, the respective processing cannot be performed unless the accessing party is verified as a member of that individual group.

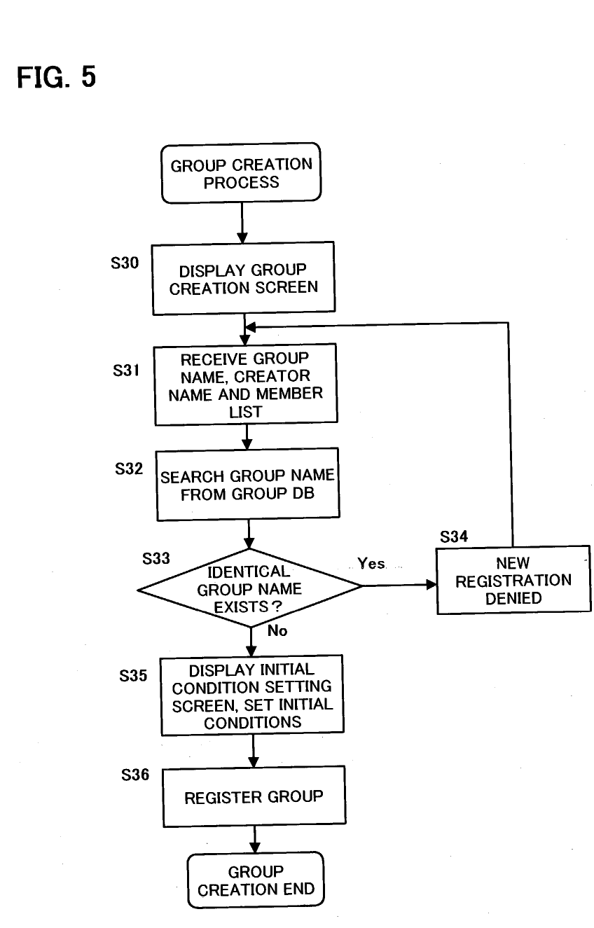

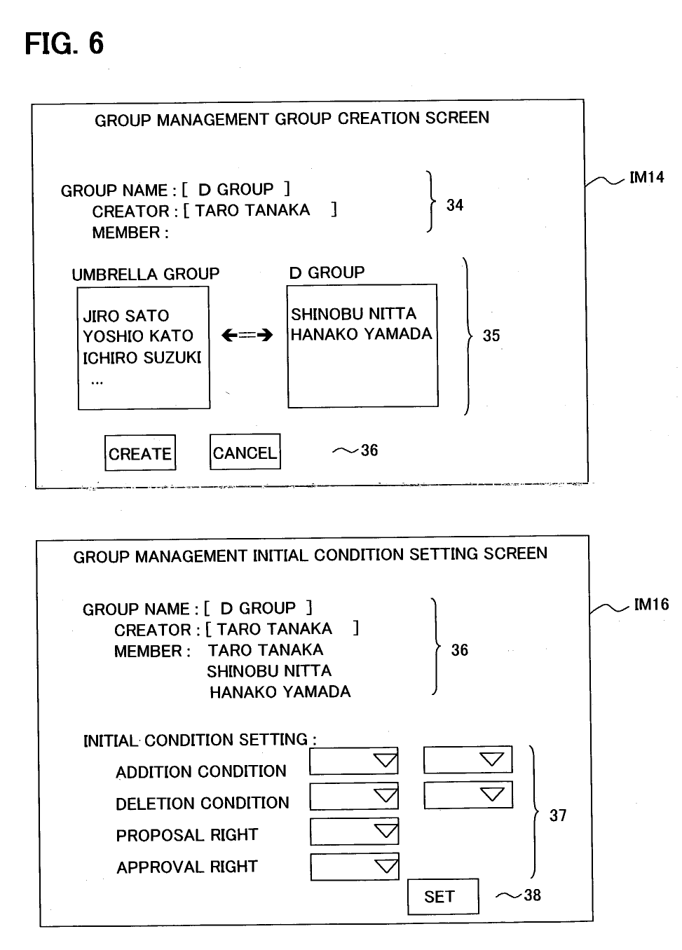

FIG. 5 is a flowchart of group creation processing. FIG. 6 is a view showing a group creation screen and an initial condition setting screen thereof. As illustrated in the flowchart in FIG. 3, when the “create group” button on the group management menu screen IM12 is clicked (S14), a group creation screen IM14 is displayed without undergoing another verification process (S15, S30). In other words, the authority to create an individual group is granted as long as the accessing party is a member of the umbrella group, and therefore, since verification as a member of the umbrella group is already complete, no new verification is performed.

The group creation screen IM14 comprises a region 34 for inputting the name of the new individual group and the name of the group creator, a region 35 for registering the members of the group, and a button region 36 for requesting creation of an individual group. A member who wishes to create a new individual group inputs the individual group name (“Group D” in the example in FIG. 6) and the name of the creator (“Taro Tanaka” in the example in FIG. 6) onto the group creation screen IM14 on the client side. Then, by designating a member of the umbrella group in the left-hand column of the member registration region 35 and clicking the arrow pointing right, this member can be registered as a member of the individual group in the right-hand column. If registration is to be cancelled, a member is designated from the individual group members in the right-hand column and the arrow pointing left is clicked, whereby that member can be deleted. When the “create” button is clicked upon completion of group name input, creator name input and member registration, the inputted information is transmitted to the web server 16.

Having received the group name, creator name and member list (S31), the group management program 18 searches the group database 24 via the database server 20 to check whether or not an identical individual group has already been registered (S32). If an identical individual group has already been registered, this new registration is denied (S34), whereby the accessing party is prompted to reinput a group name.

Having ensured that no identical individual group exists (S33), the group management program 18 transmits an initial condition setting screen IM16 to the client 10, and this screen is displayed (S35). The initial condition setting screen IM16 comprises a region 36 for displaying the individual group name, creator name and constituent members, and an initial condition setting region 37. In this embodiment, the authority to add and delete members of an individual group is provided equally to all members of the individual group. Thus, group management of the individual group is entrusted to the autonomy of the members. Note, however, that stricter or more lenient management conditions may be selected appropriately for each individual group.

The following are given as examples of the aforementioned conditions.

(1) Addition Conditions

These are conditions for permitting the addition of members and comprise, for example, a number of members required to approve an addition, a time limit on achieving this number of approving members, and so on. On the initial condition setting screen IM16, two types of condition are displayed in combination on a pull-down menu as addition conditions. In other words, the number of members required to approve the addition and the time limit on achieving this number of approving members are combined. The number of members required to approve an addition comprises a first condition according to which no other approvals are necessary if a proposal for an addition has been made, a second condition according to which a predetermined number of approvals are necessary besides the proposal for an addition, and so on. As the time limit, a specific time period such as one week or one month following the proposal for addition is selected. Setting may also be performed such that the addition conditions are satisfied after the elapse of a predetermined period of time following a proposal.

(2) Deletion Conditions

These are conditions for permitting the deletion of members and, similarly to the addition conditions, comprise a number of members required to approve a deletion, a time limit for achieving this number of approving members, a time period which must elapse following a proposal for deletion, and so on. On the initial condition setting screen IM16, two types of condition are displayed in combination on a pull-down menu as deletion conditions. A combination of a number of members required for approval and a time limit on achieving this number of approving members is one example.

The minimum number of members constituting a group is determined in accordance with the aforementioned conditions on the number of approvals required for additions and deletions. That is, if the required number of approvals including the proposal is three, then there must be at least three members of the group, and any number of members below this cannot be permitted. In so doing, the group can be prevented from naturally dying out as a result of entrusting member deletions to the autonomy of the members.

(3) Proposal Rights

These are conditions under which a member may propose an addition or deletion of another member. Since all members must be provided equally with member management authority, members must be able to obtain these proposal rights under equal conditions. As an example, a member may make a proposal on the condition that a predetermined time period following member registration has elapsed. Setting may also be performed such that proposal rights are obtained immediately after member registration. By setting as the condition for obtaining proposal rights a sufficient period of time to become accustomed to the individual group following registration as a new member, unnecessary confusion caused by a new member mistakenly proposing the addition or deletion of a member may be forestalled.

(4) Approval Rights

These are conditions for obtaining approval rights when approvals beyond that of the originator of a proposal are required as a condition for member addition or deletion. All members are provided equally with member management authority, and therefore members must also be able to obtain these approval rights under equal conditions. As an example, approval rights may be obtained on the condition that a predetermined time period following registration to the group has elapsed. It is of course possible to perform setting such that approval rights are obtained immediately after registration to the group. By providing a predetermined time period, unnecessary confusion can be avoided in the same manner as proposal rights.

As is clear from the above explanation, individual group management authority is provided equally to all members. Thus, group management can be performed more quickly in this embodiment than in the conventional example in which a manager is limited to a specific member.

When the “set” button 38 is clicked following setting of the initial conditions, the initial conditions of the new individual group are transmitted to the server 14 (S35) and the created individual group is newly registered in the group database 24 (S36).

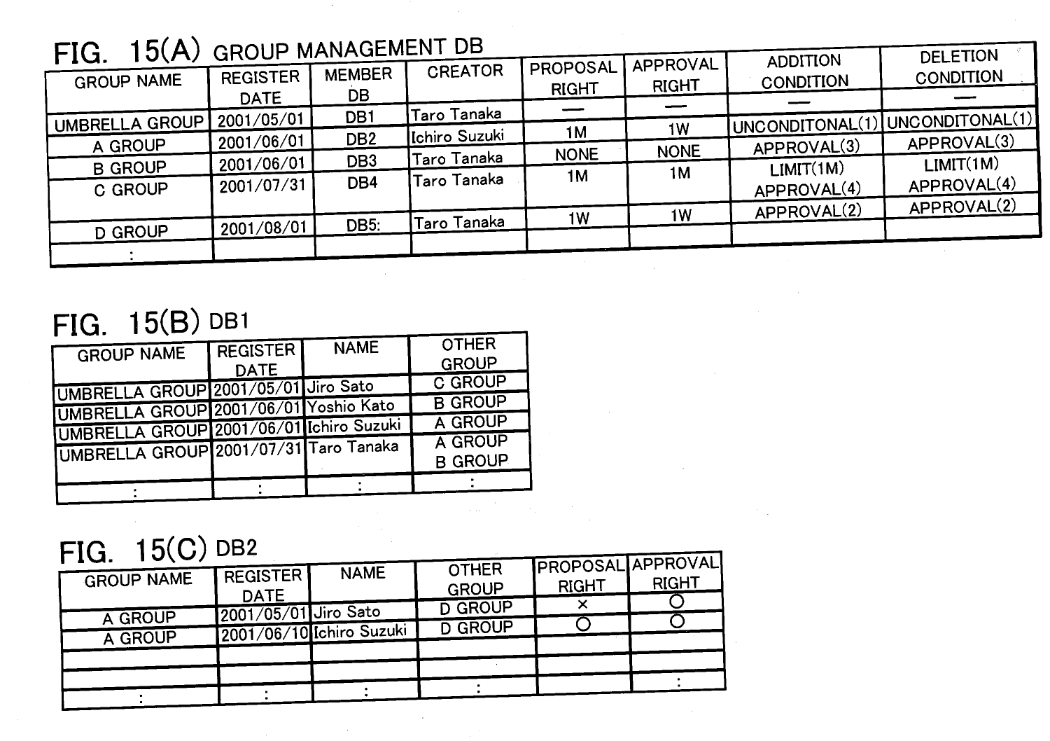

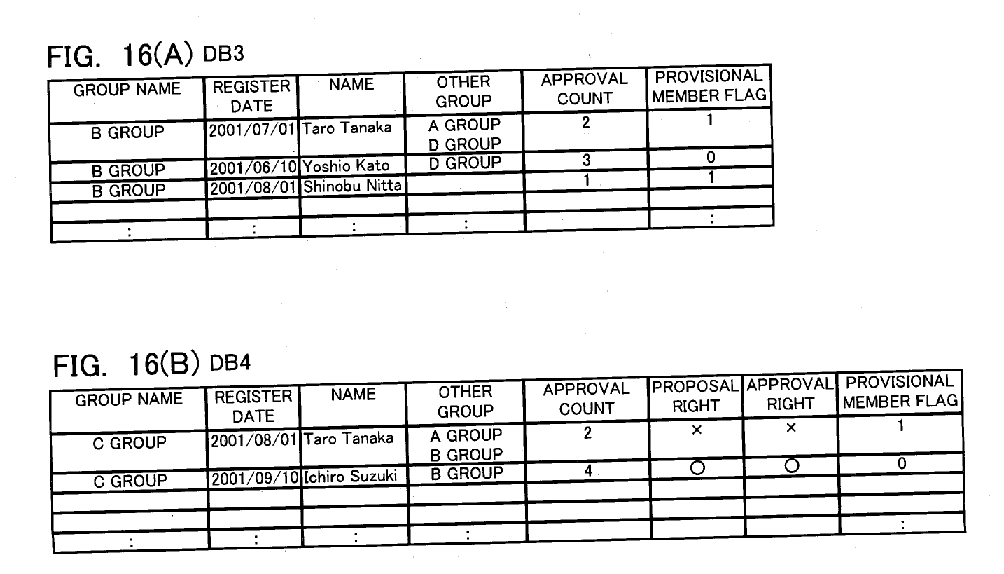

FIGS. 15 and 16 are views showing a group database. The group database 24 is constituted by a group management database (FIG. 15(A)) and databases for the members of each of the individual groups (FIG. 15(B), (C), FIG. 16(A), (B)). The group management database shown in FIG. 15(A) stores a group name, registration date, member database ID, and group creator name for each group, as well as information concerning the conditions (proposal rights, approval rights, addition conditions, deletion conditions) that are set for each group.

In the example in FIG. 15(A), the members of the umbrella group are registered in database DB1, and since this is the umbrella group, there are no set conditions. The individual groups A to D and setting conditions are registered in the respective member databases DB2 through DB5. The set conditions of Group A are set as follows: one month (1M) for acquisition of proposal rights, one week (1W) for acquisition of approval rights, and “unconditional” for addition conditions and deletion conditions. “Unconditional” signifies that no approvals other than that of the originator of the proposal are necessary. Since the originator of the proposal him/herself grants approval, the number of members required for approval is set at one. Likewise, the set conditions of Group B are as follows: no conditions are set for acquisition of proposal rights and approval rights, and three is set as the number of approvals in the addition and deletion conditions. Under these set conditions, proposal rights and approval rights are obtained immediately after registration as a member of the group, and three or more members, including the originator of the proposal, are necessary for a proposal to be approved.

The setting conditions of Group C are as follows: one month is set as the condition for acquisition of both proposal rights and approval rights, and four or more approvals within one month is set as the addition condition and the deletion condition. Thus, three or more approvals beyond that of the originator of the proposal must be granted within one month following the proposal for addition and deletion. The setting conditions of Group D are as follows: one week is set as the condition for acquisition of both proposal rights and approval rights, and two or more is set as the number of approvals in the addition condition and deletion condition.

When an individual group is newly created in this manner, the information pertaining thereto is registered in the group management database in FIG. 15(A), and the members of this individual group are registered in the respective databases DB2 to DB5.

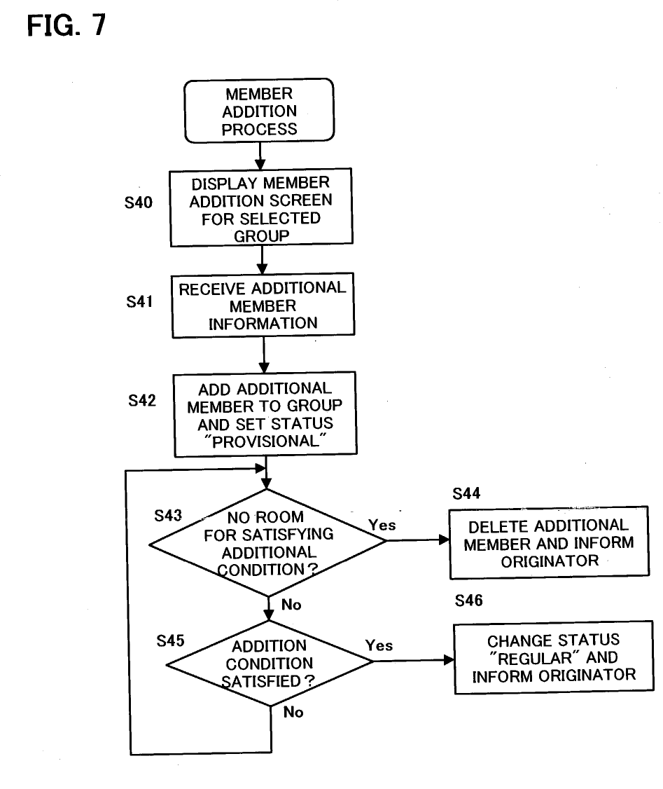

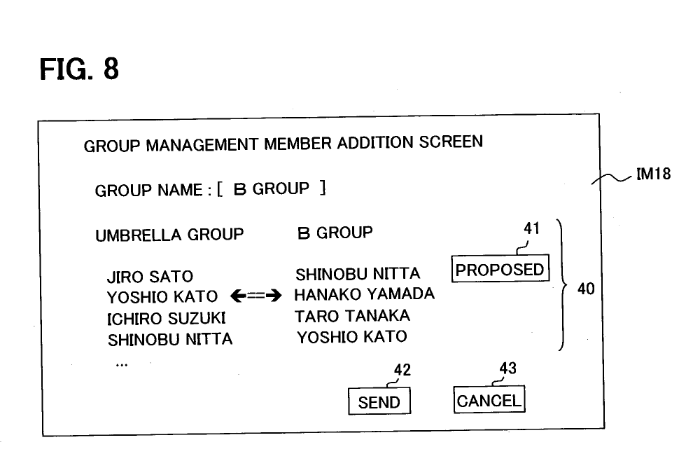

FIG. 7 is a flowchart of member addition processing in a group management program. FIG. 8 is a view showing a member addition screen. Returning to FIGS. 3 and 4, when the “add member” button is clicked (S18) following the selection of a group on the group management menu screen IM12, the group management program 18 performs background verifications as to whether the addition-requesting member is a member of the selected individual group or not and whether that member possesses proposal rights or not (S19). If these verifications are successful, a member addition screen IM18 is transmitted to the client 10 (S20). If the verifications are not successful, member addition is denied and an error display is transmitted to the client 10 (S21). Note that in the example in FIG. 8, Group B has been selected, and as is shown in FIG. 15(A), there are no particular proposal rights in Group B. Therefore, only a check to ascertain whether or not the addition-requesting member is a member of Group B is performed.

As is shown in FIG. 8, the member addition screen IM18 includes an additional member selection region 40. In the left-hand column of this region 40, the member list of the umbrella group is displayed, and in the right-hand column the member list of the selected Group B is displayed. A member to be newly added is selected on the client side from the umbrella group list, and by clicking the arrow pointing right, the additional member “Shinobu Nitta” is added to the right-hand column and a “proposed” mark 41 is displayed adjacent thereto. Then, when the “send” button 42 is clicked, the information of the additional member is transferred to the server 14 (S41). If the “cancel” button 43 is clicked, the addition proposal is cancelled.

Having received the additional member information, the group management program 18 adds the additional member to the group members and confers provisional membership status on the additional member (S42). This state is illustrated in the database DB3 in FIG. 16(A). A member named “Shinobu Nitta” is added to Group B and this member is issued a provisional membership flag of “1”. Also, since this is immediately after the addition proposal, “1” is registered as the number of approvals. As is shown in FIG. 15(A), the addition condition for Group B is set at three or more approvals, and therefore the additional member will remain under provisional membership status and will not become an officially registered member until at least three approvals have been granted.

As is shown in the flowchart in FIG. 7, when the member for whom addition has been proposed satisfies the addition conditions by obtaining at least the necessary number of approvals from other members and so on (S45), the group management program 18 modifies the status of the additional member to regular membership status (“0” in the provisional membership flag column in FIG. 16(A)) and informs the originator of the proposal of this modification by electronic mail (S46). If a time limit following proposal has been set as the addition condition and the required number of approvals has not been obtained after the time limit has elapsed, the addition conditions cannot be satisfied (S43). In this case, the group management program 18 deletes the additional member from the individual group and informs the originator of the proposal of the deletion by electronic mail or the like (S44). If a time limit following proposal has not been set as the addition condition, such deletions are not performed.

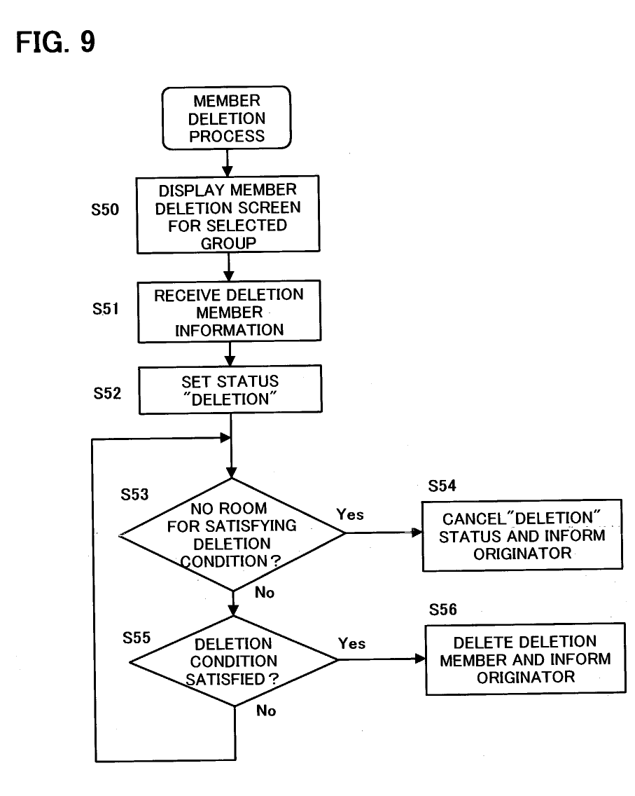

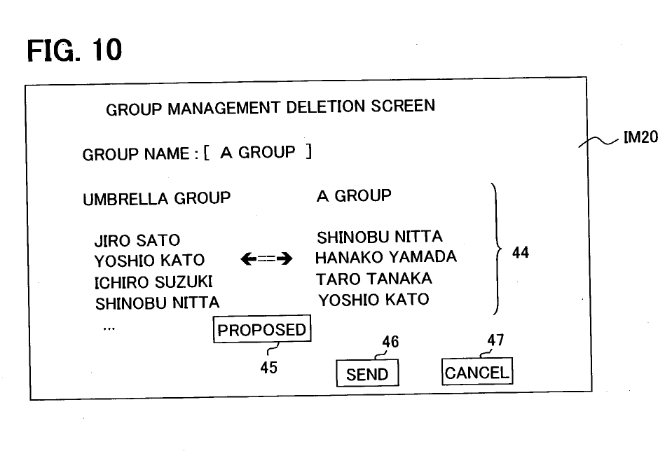

FIG. 9 is a flowchart of member deletion processing in a group management program. FIG. 10 is a view showing a member deletion screen. Similarly to member addition processing and as is shown in FIGS. 3 and 4, when the “delete member” button is clicked following selection of a group on the group management menu screen IM12 (S22), the group management program 18 performs background verifications as to whether the deletion-requesting member is a member of the selected individual group or not and whether that member possesses proposal rights or not (S23). If these verifications are successful, a member deletion screen IM20 shown in FIG. 10 is transmitted to the client 10 (S24). If the verifications are not successful, member deletion is denied and an error display is transmitted to the client 10 (S25). Note that in the example in FIG. 10, Group B has been selected, and as is shown in FIG. 15(A), there are no particular proposal rights in Group B. Therefore, only a check to ascertain whether or not the deletion-requesting member is a member of Group B is performed.

As is shown in FIG. 10, a member deletion selection region 44 is included in the member deletion screen IM20. In the left-hand column of this region 44, the member list of the umbrella group is displayed, and in the right-hand column the member list of the selected Group B is displayed. A member to be deleted is selected on the client side from the Group B list in the right-hand column, and by clicking the arrow pointing left the member to be deleted “Ichiro Suzuki” is added to the left-hand column and a “proposed” mark 45 is displayed adjacent thereto. Then, when the “send” button 46 is clicked, the information of the member to be deleted is transferred to the server 14 (S51). If the “cancel” button 47 is clicked, the deletion proposal is cancelled.

Having received the information concerning the member to be deleted (S51),the group management program 18 confers deletion status on this member to be deleted (S52). Then, if the set deletion conditions are satisfied (S55), the group management program deletes the member to be deleted from the individual group and informs the originator of the proposal of this deletion by electronic mail or the like (S56). Note that when the deletion conditions can no longer be satisfied (S53), the group management program cancels the deletion status of the member to be deleted and informs the originator of the proposal of this cancellation (S54). The deletion conditions can no longer be satsified when, for example, the required number of approvals has not been obtained after the time limit following the proposal has elapsed.

Thus, all members who are members of the individual group and who satisfy the set conditions possess the authority to make proposals for member addition or deletion. Further, the condition for obtaining authority of proposal is the elapse of a fixed time period following member registration, and is thus an equal condition for all members. It is preferable that permission to cancel a member addition or deletion proposal be limited to the originator of the proposal. In other words, members other than the originator of the proposal are only granted the authority to approve or deny that proposal.

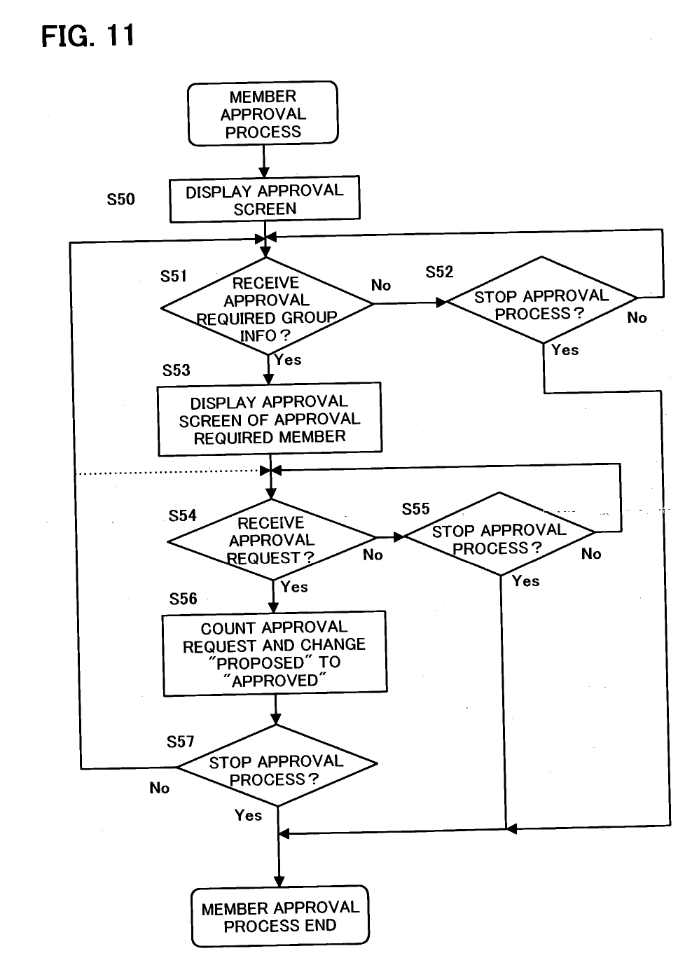

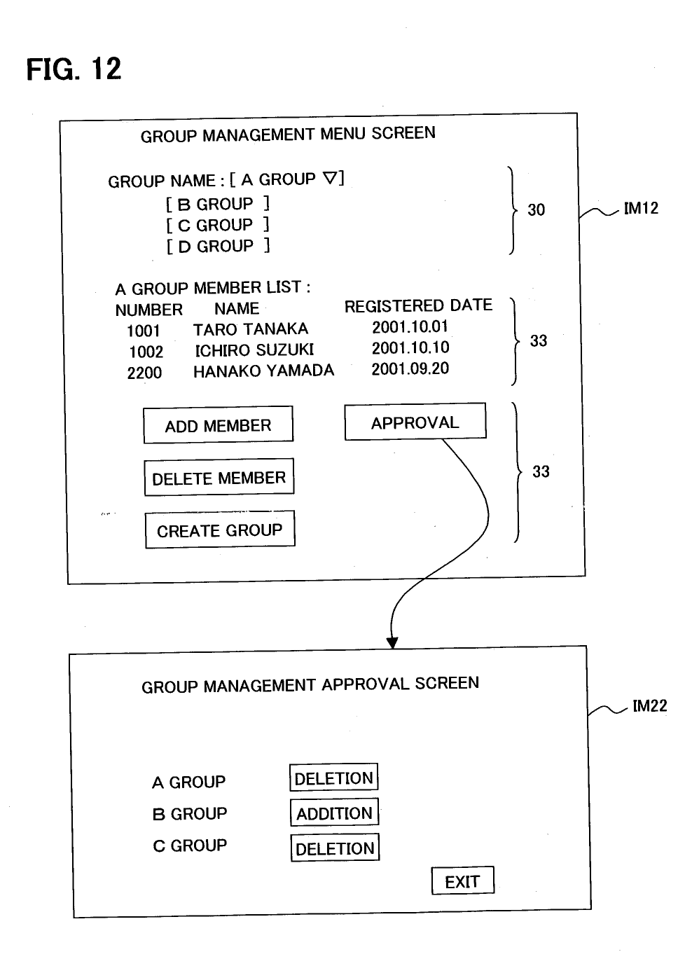

FIG. 11 is a flowchart of member approval processing in a group management program. FIGS. 12, 13 and 14 are views showing a member approval screen. If, when the group management menu screen IM12 is displayed on the client side, there is a proposal requiring approval in an individual group to which the accessing member belongs, an “approval”, button is displayed on the menu screen IM12. In other words, the group management program prompts that member to approve the proposal. Then, when approval processing is selected by clicking the “approval” button (S26), as is shown in FIG. 3, the group management program performs verification processing to check whether or not the member possesses approval rights (S27) and displays to the client an approval screen IM22 displaying individual groups for which the member possesses approval rights and in which an approval is required (S28).

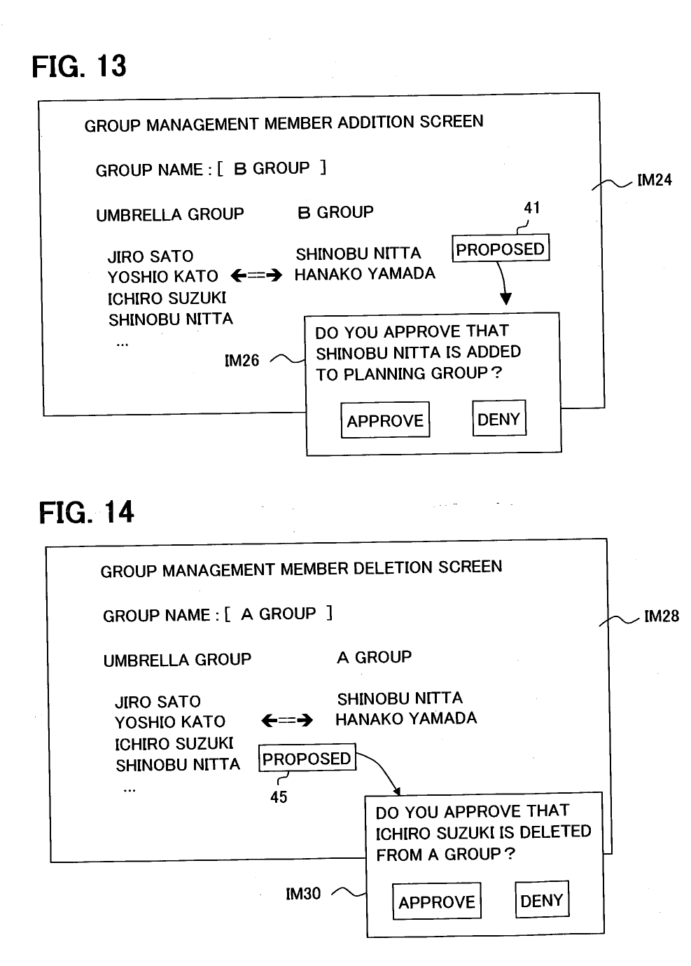

In the example in FIG. 12, the approval screen IM22 shows that addition or deletion approval are required in each of groups A, B and C. This state is indicated in step S50 in the flowchart in FIG. 11. Here, when one of the group buttons is clicked on the client side, the group management program receives the information concerning this group which is subject to approval (S51) and transmits the approval screen in either FIG. 13 or FIG. 14 to the client.

In the approval screen IM22 in FIG. 12, if addition approval for Group B is selected, the addition approval screen IM24 in FIG. 13 is displayed. This screen IM24 is identical to the member addition screen IM18 in FIG. 8. Then, when the “proposed” button 41 is clicked on the client side, the group management program displays a window screen IM26 which asks whether the proposal will be approved or denied. When either the “approve” button or the “deny” button is clicked on the client screen, this information is transmitted to the server and reflected in the member database DB3 (FIG. 16(A)). In short, if the “approve” button is clicked, the number of approvals increases, and if the “deny” button is clicked, the number of approvals does not increase.

Once the member grants approval (S54), the “proposed” display 41 on the addition approval screen IM24 changes to the word “approved” (S56). Thereafter, even if the same member clicks the “approve” button from the group menu screen IM12, the corresponding individual group is not displayed on the approval screen IM22. The corresponding individual group is also not displayed on the approval screen IM22 after the member denies approval. In the example in FIG. 13, the approval of member addition to Group B is completed and hence Group B is no longer displayed on the approval screen IM22. As a result a situation in which the member is required to grant approvals again and again can be avoided.

When notification is given from the client to end approval processing at a point during approval processing, the group management program ends approval processing and returns to the group menu screen.

Member deletion approval is performed in much the same manner. When Group A is selected from the approval screen IM22 in FIG. 12, the group management program displays the member deletion approval screen in FIG. 14. When a member has been proposed for deletion, this is indicated by a “proposed” button 42. When this “proposed” button 42 is clicked on the client side, the window screen IM26 asking whether the deletion proposal will be approved or denied is displayed. When the “approve” button is clicked on this screen IM26, the group management program counts this approval and reflects the approval in the member database DB2. Note that deletion status is not indicated in the database DB2 in FIG. 15(C).

The member databases illustrated in FIGS. 15 and 16 will now be briefly described. FIG. 15(B) is the member database DB1 for the umbrella group. This database contains the names, registration dates and other individual groups of the members belonging to the umbrella group. FIG. 15(B) is the member database DB2 for Group A, and holds member names, registration dates, other individual group names, and data concerning the proposal rights and approval rights of members. In Group A, as is shown in FIG. 15(A), since there are no addition and deletion conditions and addition and deletion are performed as soon as a proposal is made, there are no provisional membership flags, deletion proposed flags or the like in this database DB2.

FIG. 16(A) is the data base DB3 for Group B, and includes the number of approvals for member addition and a provisional membership flag. In Group B, three approvals are required for addition, and thus members who have not reached three addition approvals are indicated by a “1” (provisional membership status) in the provisional membership flag column. Members who have three or more addition approvals are indicated by a “0” (official membership status) in the provisional membership flag column.

FIG. 16(B) is the data base DB4 for Group C, and includes a number of approvals for member addition, proposal rights, approval rights, and a provisional membership flag. The addition conditions in Group C are set such that four approvals are required with in one month following proposal, and thus members who have not reached four addition approvals possess provisional membership status. Since proposal rights and approval rights are also set to be conditional, information concerning whether or not each member possesses these rights is also included.

As described above, the group management program according to this embodiment enables members to perform management autonomously by providing the members of an individual group with equal authority to add and delete members. As a result, member management of individual groups in which members change frequently can be performed in a timely fashion. There is also no need for an individual group which has a policy of autonomous administration by its members to determine a specified group manager.

According to the present invention as described above, a group management program for managing group members enables members to perform management autonomously by providing the members of an individual group with equal authority to perform membership modifications such as the addition and deletion of members.

What is claimed is:

1. A group management program which causes a computer to execute a group management procedure for a group which is constituted by a plurality of members, wherein a member database which holds information concerning the plurality of members is established, and said group management procedure comprises:
a procedure for receiving from a member a request for member modification of a group to which the member belongs; and
a procedure for reflecting a modification of member belonging to the group to said member database on the basis of the request of member modification, when a set condition concerning approval of said member modification request by a member, who belongs to said group and is different from said member who made said member modification request, are satisfied.

2. The group management program according to claim 1, wherein said procedure further comprises a procedure for accepting a creation of a group by said member, accepting setting of said condition relating to said newly created group, and registering said new group along with said set condition.

3. The group management program according to claim 1, wherein said set condition at least comprises a minimum number of approvals including said request.

4. The group management program according to claim 1, wherein said set condition comprises a combination of a minimum number of approvals including said request and a time limit to obtain said minimum number of approvals.

5. The group management program according to claim 1, wherein said set condition may include a condition that a member is granted a right to make said request or to grant an approval after the elapse of a predetermined period of time following registration as a member.

6. The group management program according to claim 2, wherein information concerning a member of the newly created group is received and registered at the time of acceptance of said group creation.

7. The group management program according to claim 1, wherein a member of a group which is subject to the management is a member of an umbrella group including the group which is subject to the management.

8. The group management program according to claim 1, wherein said group management procedure further comprises a procedure for performing verification as to whether a member accessing a group management function is a member of the group which is subject to the management.

9. The group management program according to claim 1, wherein said member modification comprises at least a member addition or a member deletion.

10. The group management program according to claim 1, wherein said request may include a proposal.

11. The group management program according to claim 1, wherein authority to perform said member modification and/or authority to grant approval is provided equally to members belonging to said group.

12. A group management method which causes a computer to execute a group management procedure for a group which is constituted by a plurality of members, wherein a member database which holds information concerning the plurality of members is established, and said group management procedure comprises the steps of:
receiving from a member a request for member modification of a group to which the member belongs; and
reflecting a modification of member belonging to the group to said member database on the basis of the request for member modification, when a set condition concerning approval of said member modification request by a member, who belongs to said group and is different from said member who made said member modification request, are satisfied.

13. The group management method according to claim 12, further comprising the step of accepting a creation of a group by said member, accepting setting of said set conditions relating to said newly created group, and registering said new group along with said set condition.

14. A group management device for a group which is constituted by a plurality of members, comprising:
a member database which holds information concerning the plurality of members;
request reception unit receiving a request from a member for member modification of a group to which the member belongs; and
modification unit reflecting a modification of member belonging to the group to said member database on the basis of the request for member modification, when a set condition concerning approval of said member modification request by a member, who belongs to said group and is different from said member who made said member modification request, are satisfied.
